(19) United States
(12) Patent Application Publication
(10) Pub. No.: US 2003/0121672 A1
(43) Pub. Date: Jul. 3, 2003

(54) Fire brigade training facility

(76) Inventors: Armin Spaniol, Oberthal (DE); Jakob Spiegel, Kaiserslautern (DE); Sasha Honsl, Ontario (CA); Richard Bell, Ontario (CA); Robert Giguere, Ontario (CA); George Aslanian, Ontario (CA)

Correspondence Address: SCHIFF HARDIN & WAITE, 6600 SEARS TOWER, 233 S WACKER DR, CHICAGO, IL, 60606-6473, US

(21) Appl. No.: 10/181,664

(22) PCT Filed: Jan. 18, 2001
(86) PCT No.: PCT/DE01/00222

(30) Foreign Application Priority Data
Jan. 20, 2000 (DE) 10002349.5

(51) Int. Cl. A62C 35/00

(52) U.S. Cl. 169/5

(57) ABSTRACT

The invention relates to a fire drill and training facility with at least one fire room in which at least one simulation fire, in particular for an item of furniture, an installed object, a piece of equipment or the like is arranged, with a flame generation device actively connected to at least the simulation fire, a smoke generation device with at least one outlet in the fire room, a ventilation device at least for the fire room, an emergency shutdown device at least for the flame generation device and smoke generation device, a parameter determination means and a control and evaluation device actively connected to the flame generation device, smoke generation device, ventilation device, emergency shutdown device and the parameter determination means, in which the parameter determination means comprises a plurality of sensors for determining the behaviour of the fire drill and training facility, in particular the operational functioning of the flame generation device, smoke generation device, ventilation device and the emergency shutdown device, the potential exposure to danger of each trainee present in the fire room and the condition and performance of each trainee, and the control and evaluation device controls the fire drill and training facility, in particular the flame generation device, smoke generation device, ventilation device and the emergency shutdown device, depending on data collected, stored and/or calculated over time by the parameter collection means, and also evaluates each trainee

The present invention relates to a fire drill and training facility with at least one fire room in which at least one simulation fire is arranged, a flame generation device actively connected to at least the simulation fire, a smoke generation device with at least one outlet in the fire room, a ventilation device for the fire room, an emergency shutdown device at least for the flame generation device and smoke generation device, a parameter determination means, and a control and evaluation device actively connected to the said flame generation device, the smoke generation device, the ventilation device, the emergency shutdown device and the parameter determination means.

Such fire drill and training facilities are indispensable in training firefighters so that they are able to handle life-threatening situations. For example, a generic fire drill and training facility is known from EP 0 388 447 B1, in which one or more fire rooms are in each case provided with at least one simulation fire, where each fire room has a floor grating and a space arranged underneath the grating in which are arranged burner units of a flame generation device, which however does not enable a realistic flame pattern to be produced.

Also, the smoke generation device of the known fire drill and training facility has its outlet arranged in the chamber underneath the floor grating, which likewise does not permit a realistic smoke propagation. Multiple sensor units are furthermore provided in each fire room in the space underneath the grating in order to record the extinguishing agent used by a trainee, on the basis of which are regulated the intensity of the spreading fire and the amount of smoke in the fire room. However, this known regulation mechanism does not take account of a large number of factors such as the position of the trainee and the nature, arrangement, orientation and alignment of the fire extinguisher and the like, with the result that an actual evaluation of the performance of the trainee is not possible, nor is it possible to simulate an emergency. Independently of the performance of the trainee, it is also not possible to determine and/or evaluate his/her bodily load-carrying capacity and the like with the known equipment. In no way do the known fire drill and training facilities enable a training in the early recognition of typical fire situations.

From EP 0 535 279 B1 a further fire drill and training facility is known, with which already more realistic flames can be produced and in which an open water tank for a specific volume of water is provided, in which distribution lines for liquid propane are arranged so that pressurised liquid propane can be squirted out from the distribution lines into the water and can flow upwardly through the water in the form of propane vapour bubbles, propane vapour then collecting on the surface of the water where it can be ignited.

The use of a large number of temperature sensors in order to determine the rate of a localised to overall temperature rise in a fire room for the purposes of automatic triggering of an emergency shutdown device, such as in the form of a water sprinkler, if a previously set threshold value is exceeded is known for example from EP 0 146 465 B1.

From U.S. Pat. No. 5,518,402 a fire drill and training facility is known in which in particular the position of the trainee can be determined, thereby enabling conclusions to be drawn as regards his/her exposure to danger. Furthermore, it is possible by using a large number of sensors to determine the performance of the trainee, and in particular to determine whether the trainee has sprayed the object to be extinguished with a sufficient amount of extinguishing agents so as to exclude the possibility of reignition of the said object.

A teaching aid for teaching and training in the use of fire extinguishing appliances is known from DE 696 03 083 T2, in which a trainee is located in front of a screen on which consecutive images showing progressive stages of a fire can be displayed according to a sequence that is remotely controlled by a computer. For this purpose the trainee stands on a contact mat that enables the position of the said trainee to be determined.

The object of the present invention is to develop and improve the generic fire drill and training facility in such a way that the disadvantages of the prior art are overcome, and in particular the training effect for firefighters is improved, i.e. the bodily condition of the firefighter can also be determined.

This object is achieved according to the invention by the fact that the parameter determination means comprises a plurality of sensors for determining the behaviour of the fire drill and training facility, including the behaviour of the operational functioning of the flame generation device, smoke generation device, ventilation device and the emergency shutdown device, for determining the exposure to danger of each trainee present in the fire room and for determining the condition and performance of each trainee, and the control and evaluation device controls the fire drill and training facility, in particular the flame generation device, the smoke generation device, the ventilation device and the emergency shutdown device depending on data collected, stored and/or calculated over time by the parameter determination means, and also assesses each trainee as regards his/her exposure to danger, condition and performance.

In this connection it may be envisaged that the sensors comprise at least one temperature sensor, in particular in wall regions around the simulation fire and in the simulation fire or fires, at least one liquid sensor for determining an amount of liquid and/or a liquid flow rate, in particular of water, at least one gas sensor for determining an amount of gas as well as a gas flow rate, in particular of oxygen, carbon monoxide, carbon dioxide and/or propane, at least one visibility sensor and/or at least one extinguishing agent sensor.

It is furthermore proposed according to the invention that an extinguishing agent sensor comprises at least one temperature sensor, a water or gas sensor, and a visibility sensor.

According to the invention it may also be provided that the sensors comprise at least one position sensor for determining the position of each trainee in the fire room and/or at least one sensor for determining the condition, such as the physiological condition, of each trainee, in particular the body temperature, heartbeat, blood pressure, degree of sweating, blood oxygen level and/or posture.

In this connection it may be provided that the position sensor comprises a plurality of elements arranged in the form of a regular grid in the floor of the fire room.

It is furthermore proposed according to the invention that the position sensor and/or the sensor for determining the condition of each trainee comprises a satellite system and/or transmitter/receiver system comprising at least one transmitter, carried by each trainee, and at least one receiver in the fire room.

Preferred embodiments of the invention are characterised in that the output data of the sensors, in particular the output data of the sensors for determining the condition as well as the performance of each trainee, can at least in part be compared with previously stored reference values for assessing each trainee, in particular as regards stress load, ability to react, efficiency and firefighting performance as determined by the choice of fire extinguishing means, fire extinguisher nozzle, orientation of the fire extinguisher nozzle, alignment of the fire extinguisher nozzle, position of the fire extinguisher nozzle or extinguishing time, and can be displayed.

Further developments of the invention are characterised by at least one light generator, a sound generator, a smell generator and/or movement mechanism actively connected to the control and evaluation device, in particular for the controlled release of previously received sequences depending on at least some of the data collected by the sensors, such as the flame state, flame propagation and room temperature.

Furthermore it may be envisaged according to the invention that the ventilation device comprises at least one combustion waste gas fan, such as in the form of a combustion gas wall-mounted fan and/or combustion gas ceiling fan, together with a volume flow regulator, preferably with the interconnection of a frequency mixer and/or frequency converter, an evacuation unit, ventilation ducts and/or shafts, filters and flaps that can be controlled via the control and evaluation device.

In this connection it may be envisaged that the ventilation device comprises heat recovery means.

It is also proposed according to the invention that in the region of each air inlet into the fire room there are arranged means, such as in the form of perforated metal sheet outlets, for generating substantially laminar flows, preferably with a flow rate of less than 1.5 m/sec in the vicinity of the floor of the fire room.

Furthermore it is preferred in accordance with the invention that smoke can be fed in in the region of each cold air inlet, in particular with the use of a propellant such as nitrogen or the like, in order to prolong the presence of the hot smoke, in particular hot smoke generated by the smoke generation device.

According to the invention it may also be envisaged that the ventilation device comprises a time switch and/or an air duct thermostat, in particular for maintaining a minimum temperature in the fire drill and training facility, preferably above 5° C., controlled via the control and evaluation device.

It may furthermore be provided that at least one gas sensor is arranged in the air ducts and is actively connected to the said control and evaluation device.

It is furthermore proposed according to the invention that the ventilation device and/or smoke generation device is/are self-cleaning.

It is preferred according to the invention to provide several fire rooms that may preferably be centrally vented and/or aerated.

Embodiments of the invention are characterised in that the control and evaluation device comprises at least one processor (central processing unit), a memory, an operating unit such as a keyboard, a computer mouse and/or a portable hand-held device, and a display unit such as a screen.

In this connection it may be envisaged to provide a plurality of processors that are linked locally or to one another and that operate independently of one another or in co-operation.

It is furthermore proposed according to the invention that the display unit and the operating unit are at least in part designed integrally, and preferably have a touch-sensitive screen.

It may also be envisaged that the hand-held device comprises at least in part the display unit.

The invention also proposes further developments which are characterised in that the display unit operates and/or does not operate a plurality of display regions for monitoring if desired a training exercise, optionally in several fire rooms, including displays of sensor output data, and comprises displays of desired parameters and displays of previously stored model procedures, preferably in each case in one display region.

It may furthermore be envisaged that the components of the fire drill and training facility communicate in a digital or analogue manner with the control and evaluation unit itself via electrical and/or electromagnetic signals.

It is furthermore preferred according to the invention that faults or interferences can be automatically localised and displayed by the display unit, preferably acoustically and/or optically, in particular in the basic layout of the fire drill and training facility.

Finally, it may also be envisaged according to the invention that steps employed to identify and/or rectify a detected fault or a detected interference can be displayed on the display unit, preferably acoustically and/or optically, and/or when predetermined threshold values of selected sensor output data are reached, a procedure can be initiated automatically by the control and display unit, in particular to terminate a training exercise, preferably via the emergency shutdown device.

The invention is thus based on the surprising result that training of firefighters in fire drill and training facilities can be both evaluated and assessed as soon as the control and evaluation device takes over two roles, namely not only the control of the components of the fire drill and training facility per se, by means of which flames and smoke can be generated, but in addition also the collection and evaluation of feedback information via a plurality of sensors that may be subdivided into three groups, namely sensors for collecting data on the operational functioning of the components of the fire drill and training facility, the exposure to danger of the trainees, as well as the condition and performance of each trainee. In this connection the values collected over time are preferably compared with previously adopted sample values or profiles in order to obtain evaluation scales or benchmarks.

The following advantages may in particular be achieved for the first time according to the invention:

By using a plurality of evaluable sensors, for example in the form of temperature sensors in the wall regions around a simulation fire and within a simulation fire, a fire extinguishing technique can be elaborated that is decisive in preventing the growth and further propagation of flames and is thus essential for the evaluation of each trainee.

Within a fire room realistic flames and smoke can be established over time as a function of a measured flame growth and a measured flame propagation. In this connection water baths according to EP 0 535 279 B1 are preferably used for the flame simulation.

Each trainee can be monitored over the complete training exercise, also as regards his/her physiological condition, in order to be able to evaluate the load-carrying capacity as well as health of each trainee. In this way exposure of the trainee to danger may also be avoided.

Special noise, smoke and light effects as well as movements of objects in a fire room may be produced in a fire room in order to train the trainee in the early recognition of known flame propagation situations such as a sudden flame propagation, in particular in the form of so-called “flash-over”, “roll-over” as well as “back draft” phenomena, which are described in detail in the non-prior-published document DE 19959640.9.

During a training exercise the situation in the fire room, in particular as regards smoke, visibility and/or flame propagation, can be altered by a training leader depending on the condition as well as performance of each trainee.

A training leader may simultaneously monitor several trainees in a fire room as well as in several fire rooms and may monitor the various elements of the overall fire drill and training facility via a display device and/or a hand-held device, on which multiple items of information may be simultaneously displayed, and may take into account such information in planning training exercises.

A training leader may also be “virtually” present at a training exercise in a fire room via the hand-held device, which for safety reasons is particularly recommended in the event of ignition of a sudden flame propagation in the form of a “flash-over”.

Faults and interferences in the fire drill and training facility according to the invention are automatically diagnosed and displayed, a corresponding display in the basic layout of the fire drill and training facility also being possible, with the result that an immediate rectification of the fault or interference, if necessary automatically, is guaranteed provided that previously set threshold values are not exceeded. As soon as the said threshold values are exceeded, then according to the invention an emergency fire extinguishing routine is automatically started for safety reasons. This monitoring also serves to minimise downtimes of the fire drill and training facility.

Further features and advantages of the invention are disclosed in the following description, in which embodiments of the invention are described in more detail with the aid of schematic diagrams, in which:

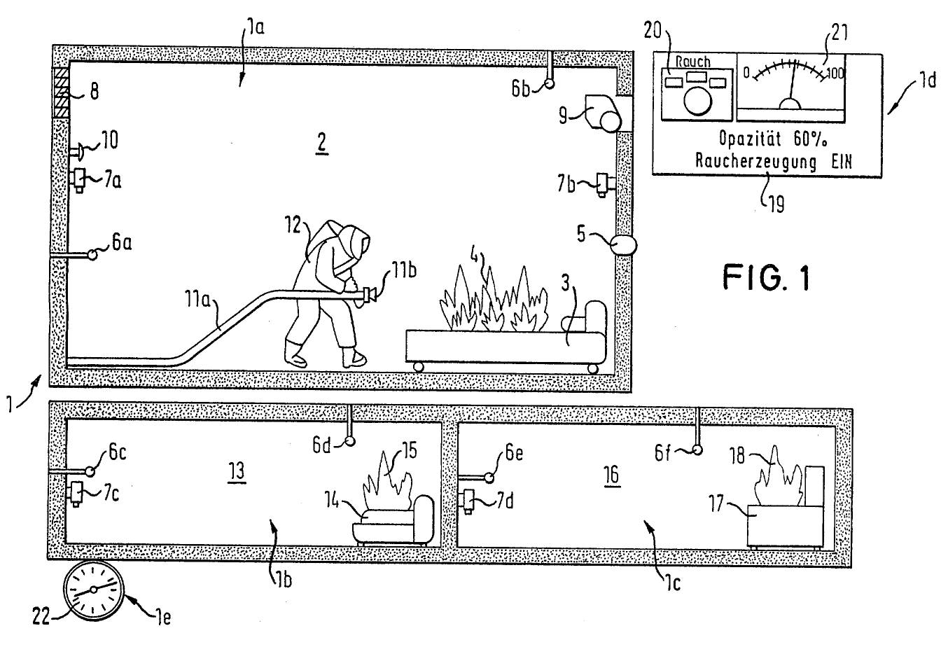

FIG. 1 is a screen display of a control and evaluation device of a fire drill and training facility according to the invention;

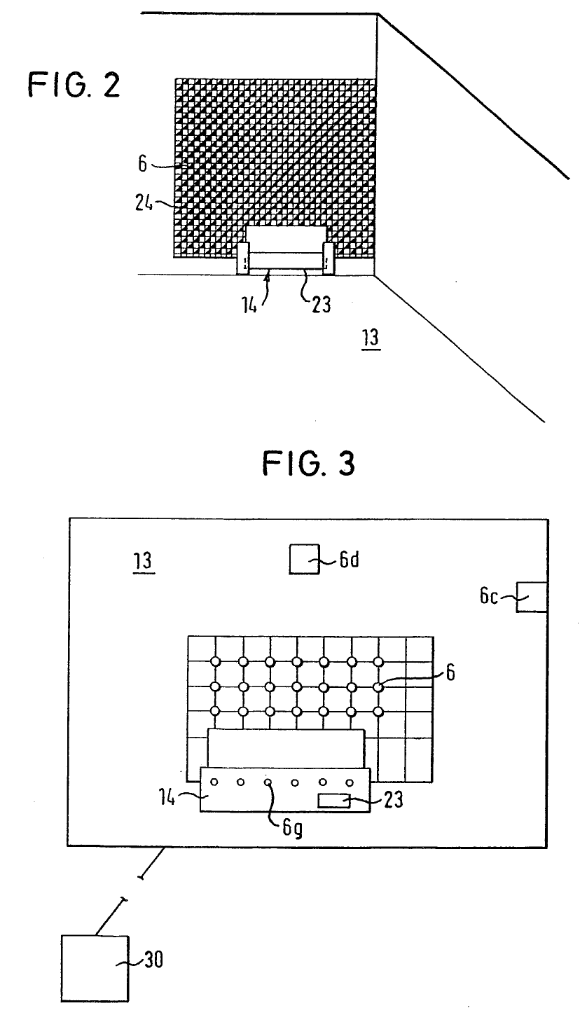

FIG. 2 is a perspective partial view of a fire room of a fire drill and training facility according to the invention;

FIG. 3 is a plan view of a fire room of a fire drill and training facility according to the invention actively connected to a control and evaluation device;

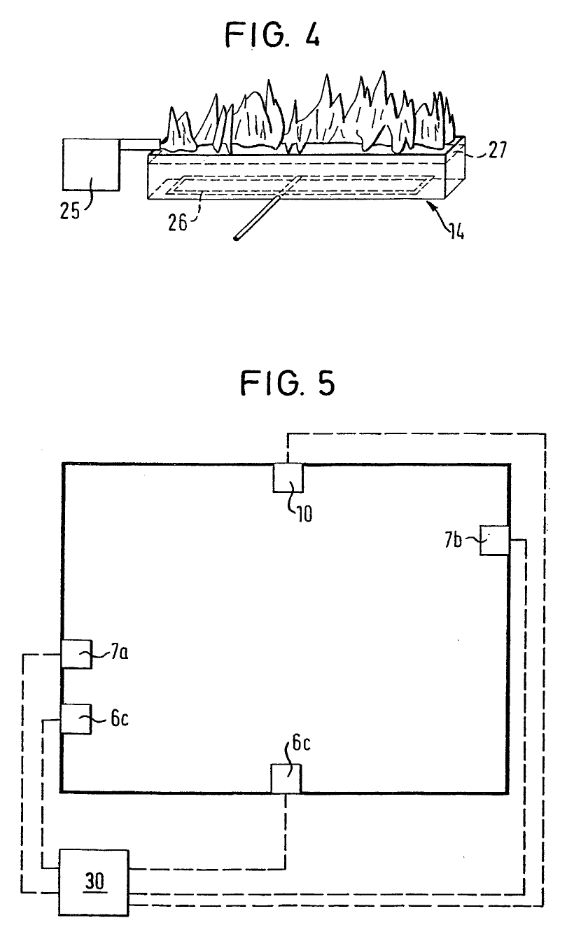

FIG. 4 is a perspective view of a simulation fire;

FIG. 5 is a longitudinal sectional view through a fire room of a fire drill and training facility according to the invention actively connected to a control and evaluation device of a fire drill and training facility according to the invention;

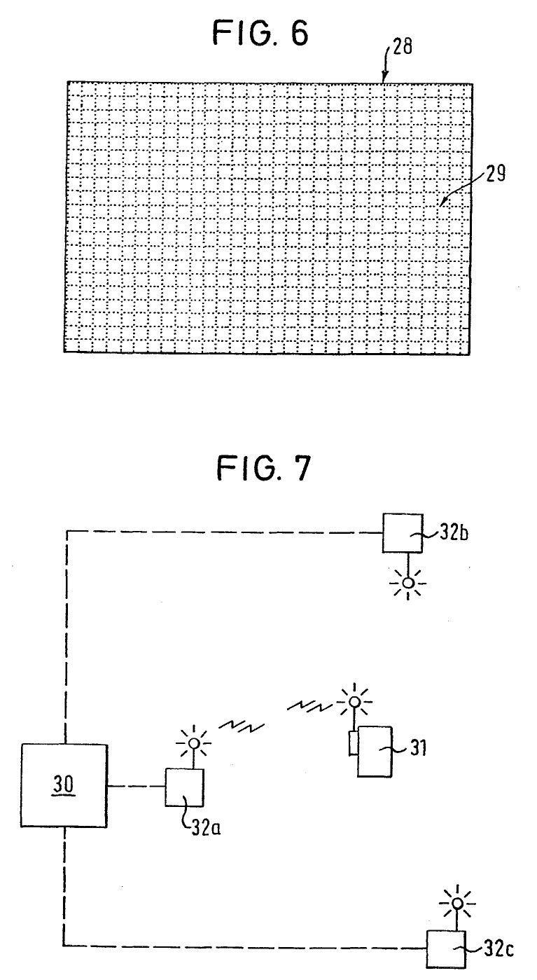

FIG. 6 is a plan view of the floor of a fire room of a fire drill and training facility according to the invention;

FIG. 7 is a view demonstrating the operational functioning of a sensor secured to a trainee and actively connected to a control and evaluation device of a fire drill and training facility according to the invention;

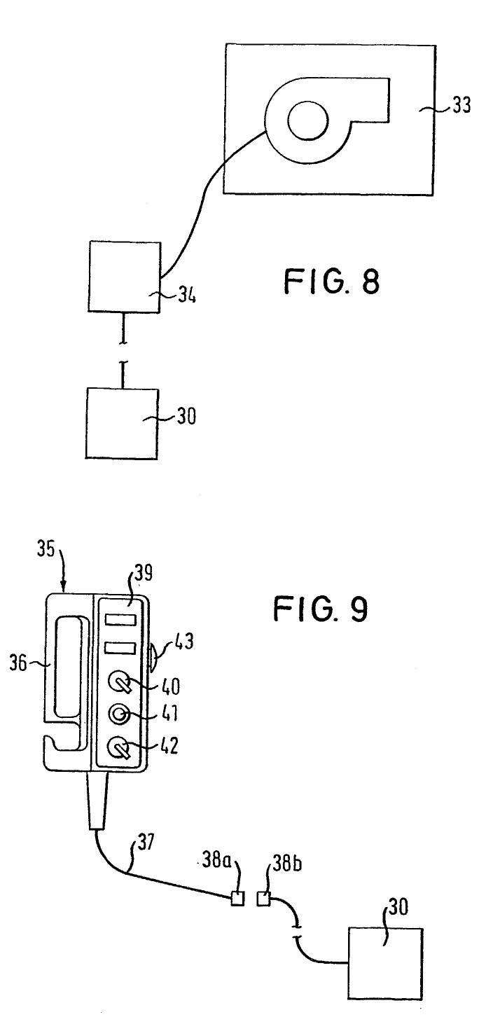

FIG. 8 is a view of a ventilation device of a fire drill and training facility according to the invention actively connected to a control and evaluation device; and

FIG. 9 is a plan view of a hand-held device actively connected to a control and evaluation device of a fire drill and training facility according to the invention.

As may be seen from FIG. 1, a control and evaluation device of a fire drill and training facility according to the invention may comprise a display unit in the form of a screen 1, from which a plurality of items of information may be simultaneously read by subdividing the screen into five screen regions 1a to 1e. In this connection the first screen region 1a shows a fire simulation bedroom 2 with a dummy bed 3 together with fire source 4, a smoke generator 5, two temperature sensors 6a, 6b, two gas sensors 7a, 7b, a ventilation system comprising an inlet 8 for substantially laminar flows and an extractor 9, an emergency shutdown switch 10, a fire extinguisher hose 11a with nozzle 11b as well as a trainee firefighter 12. The second screen region 1b shows a fire simulation living room 13 with a dummy couch 14 together with fire source 15, two temperature sensors 6c, 6d, as well as a gas sensor 7c. The third screen region 1c shows a fire simulation kitchen 16 with a dummy cooker 17, together with fire source 18, two temperature sensors 6e, 6f, as well as a smoke sensor 7d. The fourth screen region 1d shows a display unit 19 for smoke and/or visibility in the fire room, from which it can be seen that a smoke generator 20 is switched on and a high level of non-visibility of 60% exists, as can be seen from a visibility display 21. Finally, the fifth screen region le includes a clock 22. In addition to the five screen regions 1a to le that have just been described, an operating menu (not shown) is also provided in FIG. 1, which can be operated by each operator and/or training leader via a computer mouse or by touch.

FIG. 2 shows an actual simulated fire in the living room 13 with the dummy couch 14. Instead of individual temperature sensors as are shown for example in FIG. 1, in this case a plurality of temperature sensors 6 are provided according to the invention, more specifically in the form of a regular pattern in the wall region behind the dummy couch 14 as well as in the dummy couch 14 itself, the latter sensors not being shown. In addition to the temperature sensors 6, there are also arranged a fire extinguishing sensor 23 in the dummy couch 14 as well as water sensors 24 in the region of the temperature sensors 6 in the wall in order to provide a better evaluation of the performance of a trainee as well as to control the fire source.

FIG. 3 too shows the fire simulation living room 13 with the dummy couch 14, the temperature sensors 6, 6c, 6d, 6g, and the fire extinguishing sensor 23, all the sensors being connected to a control and evaluation device 30.

On the basis of the temperature changes detected by the temperature sensors 6, 6c, 6d and 6g as well as the temperature gradient changes, the fire extinguishing technique of a trainee, in particular the pattern of the sprayed fire extinguishing agent as well as the nozzle used for this purpose, can be determined.

Also details of the fire extinguishing agent used by the trainee can be determined exclusively via the evaluation of temperature sensors, flow rate sensors and visibility sensors, the fire extinguishing agent sensor 23 comprising a visibility sensor as well as a flow rate sensor The following logic algorithm may be used for this purpose:

It may be assumed that water has been used as fire extinguishing agent if the flow rate detected by the flow rate sensor lies above a specific threshold value and is maintained at this level over a certain time, while at the same time the temperature sensors 6, 6c, 6d, 6g show that the temperature is falling.

If foam is used as fire extinguishing agent, then the non-visibility detected by the visibility sensor rises above a previously determined threshold value and remains above this value for a certain period, while the detected flow rate is low.

The use of carbon dioxide as fire extinguishing agent may be assumed if there is a combination of a rapid temperature drop and a low visibility combined with a low flow rate.

FIG. 4 illustrates how a fire can be realistically simulated. For this purpose the dummy couch 14 comprises an ignition unit 25 actively connected to a combustible substance distribution tube 26 within a water bath 27. If for example liquid propane is used as combustible substance, this may be discharged from the combustible substance distribution tube 26 into the water bath 27 and then rises to the surface of the water bath in the form of propane gas bubbles which can be ignited via the ignition unit 25 to generate flames.

FIG. 5 is a sectional view through a typical fire room with two temperature sensors 6c, 6'c, two gas sensors 7a, 7b and the emergency shutdown switch 10, all sensors 6c to 7b as well as the emergency shutdown switch 10 being actively connected to the control and evaluation device 30. Via the gas sensors 7a, 7b it can be determined whether a gas level threshold value has been exceeded, which is an indication of a dangerous situation. This indication together with the temperature values and/or temperature gradients detected by the temperature sensors 6c, 6'c serves as a safety monitor to decide whether the fire drill and training facility according to the invention should be closed down, for example in the case of the actuation of the emergency shutdown switch 10. Various procedures may be carried out in order to close down the fire drill and training facility according to the invention, for example including the closure of all combustible substance feedlines and activation of an extractor device, which is described later with reference to FIG. 8.

FIG. 6 illustrates the floor 28 of a fire room, which comprises a plurality of position sensor elements 29 arranged in a regular pattern. By means of the position sensor elements 29, which are for example receivers, the position of each trainee, who carries a corresponding transmitter, can be localised accurately within the fire room. The physiological condition of each trainee can also be determined via this transmitter/receiver system.

FIG. 7 again illustrates the possibility of determining the position as well as the physiological condition of a trainee in a fire room, in which the trainee carries on his/her person a transmitter 31 that communicates with receivers 32a, 32b and 32c that are actively connected to the control and evaluation device 30.

FIG. 8 illustrates a ventilation device that comprises a fan 33 with a speed regulator 34 that is actively connected to the control and evaluation device 30.

According to the invention all fire rooms may preferably be ventilated centrally via the ventilation device. In this connection the ventilation of the fire drill and training facility takes place separately according to combustion waste air and extraction waste air, more specifically according to the following sequence, which is described briefly by way of example without reference to the accompanying figures:

Combustion waste air

One or several combustion waste air fans corresponding to the hot combustion air to be expected in the fire drill and training facility is/are employed. The ventilation volume flows in the individual fire rooms are controlled by variable, motor-driven volume flow regulators according to the combustion waste air volume flows required in the individual fire rooms. If only a few fire rooms are ventilated, the corresponding fan is adjusted to the then required volume flow by means of a frequency mixer.

The combustion waste air is in each case collected at the outlet from a fire room in ventilation ducts that are installed at a corridor crossing according to L-90 Fire Protection Qualification. A duct system of steel sheeting is installed in technical rooms built onto the outside of the fire drill and training facility. The downstream flow of the combustion air likewise takes place through specially arranged technical rooms. For this purpose external air equipment parts containing filter units and heating units for a heat recovery are installed. Axial fans that compensate only the pressure loss from external shutter-type flaps, as well as filter and heater units, are arranged downstream. Other heat recovery recording devices are installed in the waste air duct of the combustion waste air in the air direction in front of a fire gas fan, from which part of the heat of the combustion air is extracted and is fed in turn with a loss to the external air recording device via a water pipeline system as well as a buffer memory.

The flow of combustion air takes place through technical rooms due to the reduced pressure in the respective fire room. Since the air flow per fire room is fixed beforehand, the incoming air varies corresponding to the volume change due to the heating effect within each fire room.

So that the flowing air stream cannot have any direct effect on the actual fire behaviour as well as on the volume and propagation of smoke in a fire room, a perforated metal sheet outlet is installed in the region of the air inlet in the fire room, which causes the air stream to flow out in a substantially laminar manner at a speed of less than 1.5 m/sec in the vicinity of the floor. At the same time the smoke is fed by means of a nitrogen propellant into the fire room at this inlet point for the cold air, thereby ensuring a relatively long rise time of non-toxic hot smoke.

Extracted waste air

On activation of fire gas fans, shutter-type flaps are opened in the air shafts associated in each case with the fire rooms. The evacuated waste air flows through air ducts provided for this purpose so that it can be discharged from the fire drill and training facility to the atmosphere via a roof-mounted fire gas fan. The flow of the evacuated air into the individual fire rooms takes place through technical rooms and/or outer doors, which can be electrically unlocked and opened on activation of the air evacuation unit.

Normal ventilation and extraction of air

During the periods when the fire room and/or fire rooms are not actively used for fire simulation purposes, these are thoroughly ventilated by means of fire gas fans. The flow of air takes place, as described for a combustion air flow, via external air equipment parts. For this purpose the volume flows are adjusted lower by means of fans with frequency converters. Accordingly, with relatively cold external temperatures fire rooms are maintained at ca. 5° C. so as to prevent the water bath fire sites or extinguishing water freezing. The appropriate regulation is carried out in conjunction with a time switch and at least one duct thermostat in the region of the fire drill and training facility that cools down most.

Safety operation

In conjunction with a gas warning unit as part of the control and evaluation device with redundantly switched gas sensors, when a first threshold value is reached an acoustic warning is sounded and at the same time the ventilation device is switched to a higher flushing rate.

When a second threshold value is reached the fire drill and training facility, with the exception of the air extraction device, is completely shut down, the said air extraction device then effecting a 150-fold air change in the affected fire room or rooms.

The ventilation device according to the invention is also suitable for regulating the air conditions in the fire room depending on the level of training of the trainee or trainees.

FIG. 9 shows a hand-held device 35 that includes a handle 36 and a cable 37 for connection to the control and evaluation device 30 via a plug 38a and a socket 38b. The hand-held device 35 can be carried by a training leader and in each fire room can be connected to the control and evaluation device 30 by inserting the plug 38a into a socket 38b. A large number of parameters of the fire drill and training facility in the region of the control panel 39 can be controlled via the hand-held device 35. For example, the control panel 39 comprises an emergency shutdown switch 40, a switch 41 for triggering a sudden propagation of the flame, in particular a so-called “flash over”, a switch 42 for igniting a fire source, as well as a smoke switch 43 for activating a smoke generator. The hand-held device 35 thus enhances the flexibility of the overall fire drill and training facility as well as the safety of the trainees.

The features disclosed in the preceding description, drawings, as well as in the claims may be essential both individually as well as in any arbitrary combination for the realisation of the invention in its various embodiments.

1. Fire drill and training facility with at least one fire room (2, 13, 16) in which at least one simulation fire (3, 14, 17) is arranged,
a flame generation device (25, 26, 27, 41, 42) actively connected to at least the simulation fire (3, 14, 17),
a smoke generation device (5, 20, 43) with at least one outlet in the fire room (2, 13, 16), a ventilation device (8, 9, 33, 34) for the fire room (2, 13, 16),
an emergency shutdown device (10, 40) at least for the flame generation device (25, 26, 27) and smoke generation device (5),
a parameter determination means (6, 6a-6g, 6'c, 7a-7d, 23, 24, 29, 31, 32a-32c) and a control and evaluation device (30) actively connected to the flame generation device (25, 26, 27), smoke generation device (5), ventilation device (8, 9, 33, 34), emergency fire extinguishing device (10, 40) and the parameter determination means (6, 6a-6g, 6'c, 7a-7d, 23, 24, 29, 31, 32a-32c), characterised in that the parameter determination means comprises a plurality of sensors (6, 6a-6g, 6'c, 7a-7d, 23, 24, 29, 31, 32a-32c) for determining the behaviour of the fire drill and training facility, including the behaviour of the operational functioning of the flame generation device (25, 26, 27, 41, 42), smoke generation device (5, 20, 43), ventilation device (8, 9, 33 34) and the emergency fire extinguishing device (10, 40), for determining the potential exposure to danger of each trainee (12) present in the fire room (2, 13, 16) and for determining the condition and performance of each trainee (12), and the control and evaluation device (30) controls the fire drill and training facility, the flame generation device (25, 26, 27, 41, 42), the smoke generation device (5, 20, 43), the ventilation device (8, 9, 33 34) and the emergency fire extinguishing device (10, 40) depending on data collected, stored and/or calculated over time by the parameter determination means (6, 6a-6g, 6'c, 7a-7d, 23, 24, 29, 31, 32a-32c), and also evaluates each trainee (12) as regards his/her exposure to potential danger, condition and performance.

2. Fire drill and training facility according to claim 1, characterised in that the sensors comprise at least one temperature sensor (6, 6a-6g, 6'c) in the wall regions around the simulation fire (3, 14, 17) and in the simulation fire (3, 14, 17) or fire dummies themselves (3, 14, 17),
at least one liquid sensor (24) for determining an amount of liquid and/or a liquid flow rate, in particular of water,
at least one gas sensor (7a-7d) for determining an amount of gas as well as a gas flow rate, in particular of oxygen, carbon monoxide, carbon dioxide and/or propane, as well as at least one visibility sensor and/or at least one fire extinguishing sensor (23).

3. Fire drill and training facility according to claim 2, characterised in that
a fire extinguishing sensor (23) comprises at least one temperature sensor, a water or gas sensor, and a visibility sensor.

4. Fire drill and training facility according to one of the preceding claims, characterised in that
the sensors comprise at least one position sensor (29, 31, 32a-32c) for determining the position of each trainee (12) in the fire room (2, 13, 16) and/or
at least one sensor for determining the condition, such as the physiological condition, of each trainee, in particular the body temperature, heartbeat frequency, blood pressure, debree of sweating, blood oxygen level and/or posture.

5. Fire drill and training facility according to claim 4, characterised in that
the position sensor comprises a plurality of elements (29) arranged in the form of a regular grid in the floor (28) of the fire room (2, 13, 16).

6. Fire drill and training facility according to claim 4 or 5, characterised in that
the position sensor and/or the sensor for determining the condition of each trainee comprises a satellite system and/or a transmitter/receiver system including at least one transmitter (31) carried by each trainee (12), and at least one receiver (32a-32c), in the fire room (2, 13, 15).

7. Fire drill and training facility according to one of the preceding claims, characterised in that
the output data of the sensors (6, 6a-6g, 6'c, 7a-7d, 23, 24, 29, 31, 32a-32c), in particular the output data of the sensors for determining the condition as well as output of each trainee (12), can be compared at least in part with previously stored reference values for assessing each trainee (12), in particular as regards stress level, ability to react, efficiency and fire extinguishing performance, as determined by the choice of fire extinguishing agent, fire extinguisher nozzle, orientation of the extinguisher nozzle, alignment of the extinguisher nozzle, position of the fire extinguisher nozzle or extinguishing time, and such data can be displayed.

8. Fire drill and training facility according to one of the preceding claims, characterised by at least one light generator, a sound generator, a smell generator and/or a movement mechanism actively connected to the control and evaluation device (30), in particular for the controlled output of previously received sequences depending on at least some of the data, such as flame state, flame propagation and room temperature, collected by the sensors (6, 6a-6g, 6'c, 7a-7d, 23, 24, 29, 31, 32a-32c).

9. Fire drill and training facility according to one of the preceding claims, characterised in that
the ventilation device (8, 9, 33 34) comprises at least one combustion waste air fan, such as in the form of a fire gas wall-mounted fan and/or fire gas ceiling-mounted fan, together with volume flow regulator, preferably with the interconnection of a frequency mixer and/or frequency converter, an air extraction unit, ventilation ducts and/or shafts, filters and flaps, which can be controlled via the control and evaluation device (3).

10. Fire drill and training facility according to claim 9, characterised in that the ventilation device (8, 9, 33 34) comprises heat recovery means.

11. Fire drill and training facility according to claim 9 or 10, characterised in that
a means, such as in the form of perforated metal sheet outlets, for generating substantially laminar flows, preferably with a speed of less than 1.5 m/sec in the vicinity of the floor of the fire room (2, 13, 16), is arranged in the region of each air inlet in the fire room (2, 13, 16).

12. Fire drill and training facility according to one of claims 9 to 11, characterised in that in the region of each cold air inlet smoke can be fed in, in particular using a propellant such as nitrogen or the like, in order to prolong the presence of hot smoke, in particular hot smoke generated by the smoke generation device.

13. Fire drill and training facility according to one of claims 9 to 12, characterised in that the ventilation device (8, 9, 33 34) comprises a time switch and/or an air duct thermostat, in particular for maintaining a minimum temperature in the fire drill and training facility, preferably above 5° C., controlled via the control and evaluation device (30).

14. Fire drill and training facility according to one of claims 9 to 13, characterised in that at least one gas sensor is arranged in the air ducts and is actively connected to the control and evaluation device (30).

15. Fire drill and training facility according to one of the preceding claims, characterised in that
the ventilation device (8, 9, 33 34) and/or the smoke generation device (5) is/are self cleaning.

16. Fire drill and training facility according to one of the preceding claims, characterised in that
several fire rooms (2, 13, 16) are provided that are preferably centrally ventilated and/or aerated.

17. Fire drill and training facility according to one of the preceding claims, characterised in that
the control and evaluation device (30) comprises at least one processor, a memory, an operating unit such as a keyboard, a computer mouse and/or a portable hand-held device (35), and a display unit such as a screen (1).

18. Fire drill and training facility according to claim 17, characterised in that several processing units are provided that are coupled locally or to one another, and that operate independently of one another or in co-operation with one another.

19. Fire drill and training facility according to claim 17 or 18, characterised in that
the display unit and the operating unit are designed at least in part integrally, and preferably have a touch-sensitive screen.

20. Fire drill and training facility according to one of claims 17 to 19, characterised in that the hand-held device at least partly comprises the display unit.

21. Fire drill and training facility according to one of claims 17 to 20, characterised in that the display unit (1) comprises a plurality of display regions (1a-1e) for the optional monitoring of a trainee, possibly in several fire rooms (2, 13, 16), display of processed and/or non-processed sensor output data, display of desired parameters, and display of previously stored model procedures, preferably in each case in a display region (1a-1e).

22. Fire drill and training facility according to one of the preceding claims, characterised in that
the components of the fire drill and training facility communicate in a digital or analogue manner via electrical and/or electromagnetic signals with the control and evaluation unit itself.

23. Fire drill and training facility according to one of the preceding claims, characterised in that
faults or interferences can be localised and displayed automatically by the display unit, preferably acoustically and/or optically, in particular in the basic layout of the fire drill and training facility.

24. Fire drill and training facility according to one of the preceding claims, characterised in that
steps for the diagnosis and/or rectification of a detected fault or a detected interference can be displayed, preferably acoustically and/or optically, on the display unit, and/or when previously determined threshold values of selected sensor output data are reached, a procedure can automatically be initiated by the control and display unit, in particular for terminating a training exercise, preferably by the emergency shutdown device.
